(19) United States
(12) Patent Application Publication
(10) Pub. No.: US 2022/0332550 A1
(43) Pub. Date: Oct. 20, 2022

(54) CONTROL SYSTEM AND WORK MACHINE

(71) Applicant: TADANO LTD., Kagawa (JP)

(72) Inventor: Yoshimasa MINAMI, Kagawa (JP)

(73) Assignee: TADANO LTD., Kagawa (JP)

(21) Appl. No.: 17/640,190

(22) PCT Filed: Sep. 25, 2020
(86) PCT No.: PCT/JP2020/036257

§ 371 Date: Mar. 3, 2022

(30) Foreign Application Priority Data
Sep. 25, 2019 (JP) 2019-174638

(51) Int. Cl. B66C 13/46; B66C 23/88

(52) U.S. Cl. CPC B66C 13/46; B66C 23/88; B66C 23/36

(57) ABSTRACT

The present invention pertains to a control system incorporated in a work machine having an arm section including a boom that is freely raised and lowered, the control system including: an image-capturing unit that is provided at a distal end of the arm section and captures an image of an area below; a display unit that displays an image captured by the image-capturing unit; and a control unit that causes the display unit to display position-related information regarding a position directly below the distal end of the arm section so as to be superimposed on the image.

### TECHNICAL FIELD

The present invention relates to a control system and a work machine.

### BACKGROUND ART

Conventionally, a crane having a boom has a problem of “cargo swing” indicating that a cargo swings in the horizontal direction due to an increase in a working radius caused by deflection of the boom when the cargo is lifted from the ground, that is, when the cargo is lifted off the ground (see FIG. 1).

A vertical liftoff control device disclosed in Patent Literature 1 is configured to detect the rotation speed of an engine by an engine speed sensor and correct a value of a boom raising operation to a value corresponding to the rotation speed of the engine in order to prevent swing of a cargo when the cargo is lifted off the ground. Patent Literature 1 indicates that, with such a configuration, it is possible to perform accurate liftoff control in consideration of a change in rotation speed of the engine.

However, conventional liftoff control devices including the liftoff control device disclosed in Patent Literature 1 perform control using two actuators (winch and derricking cylinder) in combination so as to keep the working radius constant by hoisting an extended amount of wire with a winch and raising a boom.

### CITATION LIST

### Patent Literature

Patent Literature 1: JP 8-188379 A

### SUMMARY OF THE INVENTION

### Problems to be Solved by the Invention

However, the conventional liftoff control device is based on the premise that the distal end of the boom is positioned directly above the position of the center of gravity of the cargo, and thus, is difficult to exhibit the effect when the initial position of the distal end of the boom is not located directly above the position of the center of gravity of the cargo.

In view of this, an object of the present invention is to provide a control system that can easily bring an initial position of the distal end of a boom close to a position directly above the position of the center of gravity of a cargo using a camera, and a work machine including the control system.

### Solutions to Problems

A control system according to one aspect of the present invention is

incorporated in a work machine having an arm section including a boom that is freely raised and lowered, the control system including:

an image-capturing unit that is provided at a distal end of the arm section and captures an image of an area below;

a display unit that displays an image captured by the image-capturing unit; and

a control unit that causes the display unit to display position-related information regarding a position directly below the distal end of the arm section so as to be superimposed on the image.

A work machine according to one aspect of the present invention includes:

an arm section including a boom that is freely raised and lowered; and

the control system described above.

### Effects of the Invention

According to the present invention, it is possible to provide a control system and a work machine that allow an operator to easily bring an initial position of a distal end of a boom close to a position directly above the position of the center of gravity of a cargo.

### BRIEF DESCRIPTION OF DRAWINGS

FIG. 1 is an explanatory view for describing swing of a cargo.

FIG. 2 is a side view of a mobile crane.

FIG. 3 is a block diagram of a liftoff control device.

FIG. 4 is a graph illustrating a relationship between a load and a raising angle.

FIG. 5 is a block diagram entirely illustrating the liftoff control device.

FIG. 6 is a block diagram illustrating liftoff control.

FIG. 7 is a flowchart of the liftoff control.

FIG. 8 is a monitor image that displays a marker superimposed on a captured image.

FIG. 9A is a graph for describing a concept of liftoff determination.

FIG. 9B is a graph for describing the concept of liftoff determination.

FIG. 9C is a graph for describing the concept of liftoff determination.

FIG. 10 is a flowchart illustrating a liftoff determination method.

### DESCRIPTION OF EMBODIMENTS

Embodiments of the present invention will now be described with reference to the accompanying drawings. It is to be noted that the components described in the following embodiments are merely examples, and the technical scope of the present invention is not limited thereto.

### Embodiments

In the present embodiment, a mobile crane which is an example of a work machine will be described. Examples of the mobile crane include a rough terrain crane, an all-terrain crane, and a truck crane. A rough terrain crane will be described below as an example of the mobile crane according to the present embodiment, but a control system according to the present invention can also be applied to other types of mobile cranes. In addition, the present invention can be applied not only to mobile cranes but also to other types of lifting devices using wire ropes. Therefore, the work machine is not limited to the mobile crane. The work machine may indicate various working machines having an arm section including a boom that is freely raised and lowered.

(Configuration of Mobile Crane)

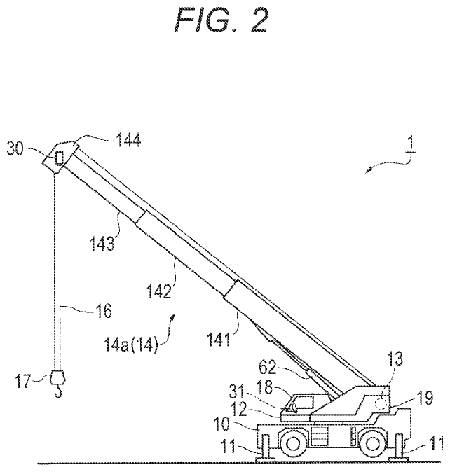

First, a configuration of a mobile crane will be described with reference to a side view of FIG. 2. As illustrated in FIG. 2, the mobile crane 1 according to the present embodiment includes a chassis 10 serving as a main body of a vehicle having a traveling function, outriggers 11 provided at four corners of the chassis 10, a slewing base 12 attached to the chassis 10 so as to be capable of slewing in the horizontal direction, and an arm section 14 (boom 14a) attached to the rear part of the slewing base 12.

Each of the outriggers 11 can be extended outward and retracted from/into the chassis 10 in the width direction in a slidable manner by extending and contracting a slide cylinder, and can be extended and retracted from/into the chassis 10 in the vertical direction by extending and contracting a jack cylinder.

The slewing base 12 includes a pinion gear to which power of a slewing motor 61 is transmitted. The slewing base 12 rotates about a rotation axis with the pinion gear meshing with a circular gear provided on the chassis 10. The slewing base 12 includes an operator cab 18 disposed on the right front side and a counterweight 19 disposed on the rear side. The operator cab 18 is equipped with a monitor 31 that displays an image captured by a camera 30 (described later).

Furthermore, a winch 13 for hoisting and lowering a wire rope 16 is disposed on the rear part of the slewing base 12. The winch 13 rotates in two directions, which are hoisting direction (take-up direction) and lowering direction (feeding direction), by rotating a winch motor 64 in the forward direction and the reverse direction.

The boom 14a has a telescopic structure including a base boom 141, (one or a plurality of) intermediate boom(s) 142, and a tip boom 143, and can be extended and retracted by a telescoping cylinder 63 disposed inside the boom 14a. The tip boom 143 is provided with a sheave attached to a boom head 144 on the most distal end. A wire rope 16 is wound around the sheave, and a hook 17 is hung from the sheave. As described later, the camera 30 that captures an image of an area below is attached to a side surface (a left side surface in the drawing) of the boom head 144.

A root portion of the base boom 141 is rotatably attached to a support shaft mounted on the slewing base 12, and can be raised and lowered about the support shaft as a rotation center. A derricking cylinder 62 is provided between the slewing base 12 and the lower surface of the base boom 141, and the boom 14a can be entirely raised and lowered by extending and contracting the derricking cylinder 62.

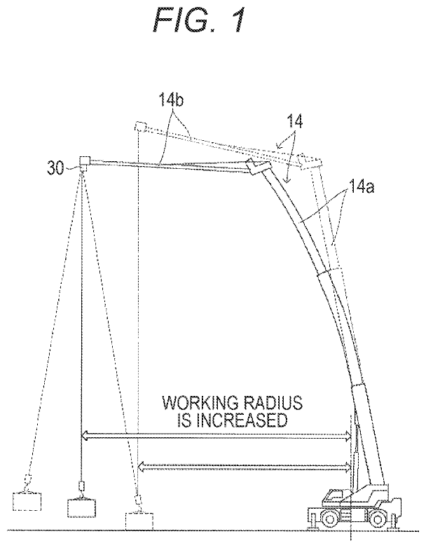

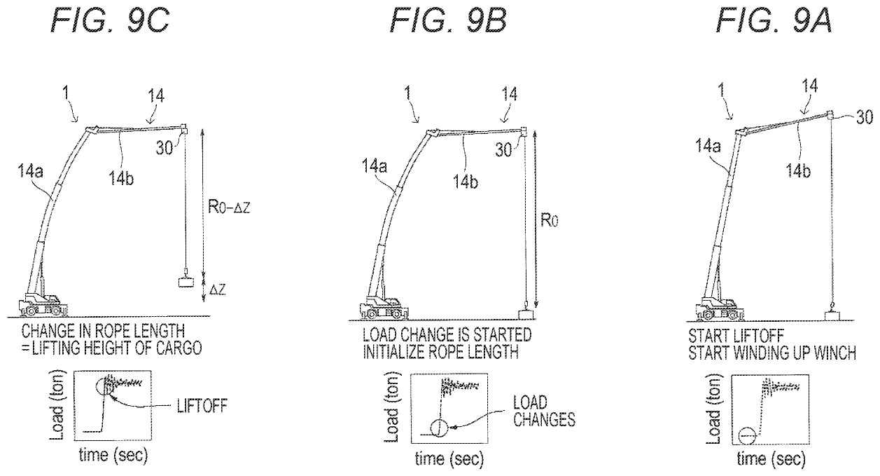

Note that the mobile crane 1 illustrated in FIG. 2 includes only the boom 14a as the arm section. However, the arm section may include, for example, the boom 14a and a jib 14b supported on the distal end of the boom 14a as illustrated in FIGS. 1 and 9A to 9C. The distal end of the arm section indicates the distal end of the boom when the mobile crane includes only the boom. On the other hand, when the mobile crane includes the boom 14a and the jib 14b, the distal end of the arm section indicates the distal end of the jib 14b.

(Configuration of Control System)

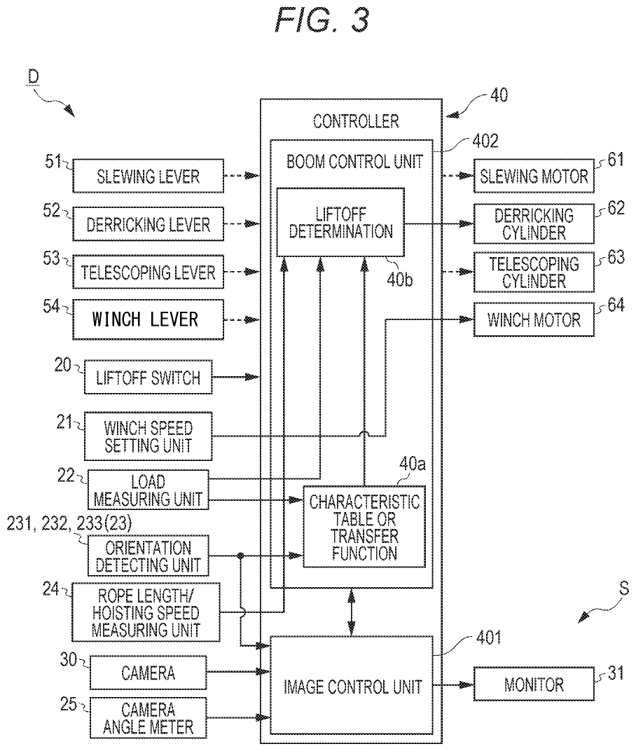

Next, a configuration of a control system of a liftoff control device D including the control system S according to the present embodiment will be described with reference to a block diagram of FIG. 3. The liftoff control device D mainly includes a controller 40 having functions as an image control unit 401 and a boom control unit 402 as will be described later. The controller 40 is a general-purpose microcomputer including an input port, an output port, an arithmetic device, and the like. The controller 40 receives operation signals from a slewing lever 51, a derricking lever 52, a telescoping lever 53, and a winch lever 54, which are operation levers, and controls a slewing motor 61, a derricking cylinder 62, a telescoping cylinder 63, and a winch motor 64, which are actuators, via control valves (not illustrated).

Furthermore, the controller 40 according to the present embodiment is connected with a liftoff switch 20 for starting/stopping the liftoff control, a winch speed setting unit 21 for setting the speed of the winch 13 during the liftoff control, a load measuring unit 22 for measuring a load acting on the boom 14a, an orientation detecting unit 23 for detecting the orientation of the boom 14a, and a rope length/hoisting speed measuring unit 24 for measuring the rope length of the wire rope 16. In addition, deflection angle information based on the weight of the boom 14a is stored in advance in a storage device of the controller 40.

The liftoff switch 20 is an input device for instructing to start or stop the liftoff control. The liftoff switch 20 can be added to a safety device of the mobile crane 1, for example, and is preferably disposed in the operator cab 18.

The winch speed setting unit 21 is an input device that sets the speed of the winch 13 during the liftoff control, and may have a system of selecting an appropriate speed from a preset speed or a system of receiving a speed input via a numeric keypad. Further, similar to the liftoff switch 20, the winch speed setting unit 21 can be added to the safety device of the mobile crane 1, and is preferably disposed in the operator cab 18. Adjusting the speed of the winch 13 by the winch speed setting unit 21 can reduce a time required for the liftoff control.

The load measuring unit 22 is a measuring instrument that measures a load acting on the boom 14a, and can be, for example, a pressure gauge that measures a pressure acting on the derricking cylinder 62. A pressure signal measured by the pressure gauge is transmitted to the controller 40.

The orientation detecting unit 23 is a measuring instrument that detects the orientation of the boom 14a, and includes a raising angle meter 231 that measures a raising angle of the boom 14a, a raising angular velocity meter 232 that measures a raising angular velocity, and a boom length meter 233. Specifically, a potentiometer can be used as the raising angle meter 231. As the raising angular velocity meter 232, a stroke sensor attached to the derricking cylinder 62 can be used. In addition, the boom length meter 233 can be constituted by a wire attached to the boom head 144 and a winding reel. A raising angle signal measured by the raising angle meter 231, a raising angular velocity signal measured by the raising angular velocity meter 232, and a boom length signal measured by the boom length meter 233 are transmitted to the controller 40.

The rope length/hoisting speed measuring unit 24 measures the rope length of the wire rope 16, and can be, for example, a rotation speed meter (so-called rotary encoder) that measures the rotation speed of the winch motor 64. The rotation speed meter directly measures the number of rotations of the winch 13, and thus has very good responsiveness. Obviously, the rope length/hoisting speed measuring unit 24 can also detect a temporal change in the rope length, so that the rope length/hoisting speed measuring unit 24 can also be used as a hoisting speed measuring unit.

The camera 30 corresponds to an example of an image-capturing unit, and is a video camera capable of capturing a moving image in real time. The image captured by the camera 30 is displayed in the monitor 31 via the image control unit 401. The camera 30 is a so-called active video camera, and is controlled to automatically face downward. The camera 30 is equipped with a camera angle meter 25, so that an angle (orientation) of the camera 30 with respect to the boom head 144 (distal end of the arm section) is measured and transmitted to the controller 40.

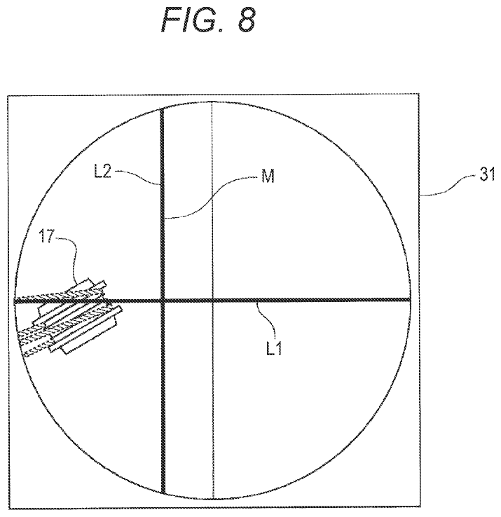

The controller 40 corresponds to an example of a control unit, and has a function as the image control unit 401 that controls an image displayed in the monitor 31 as described above. The image control unit 401 of the controller 40 causes the monitor 31 to display a cross line serving as a marker M so as to be superimposed on the captured image as illustrated in FIG. 8. The marker M indicates a position directly below the boom head 144 located at the distal end of the boom 14a. That is, a laterally extending line L1 of the cross line indicates a position in the front-rear direction (direction in which the telescoping direction of the boom 14a is projected onto the ground surface) directly below the boom head 144 in an imaged region, and a longitudinally extending line L2 of the cross line indicates a position in the horizontal direction (direction orthogonal to the direction in which the telescoping direction of the boom 14a is projected onto the ground surface) directly below the boom head 144 in the imaged region. In the present embodiment, the cross line corresponds to an example of position-related information regarding a position directly below the distal end of the arm section.

Here, the mode of displaying a cross line as the marker M has been described. However, the display mode of the marker is not limited to the cross line. The marker may be displayed in a mode in which, for example, a circle, a quadrangle, a triangle, or the like is displayed at a position directly below the distal end of the boom 14a, or in a mode in which these marks are displayed in combination. Furthermore, it is also possible to display a circle separated from the marker M (that is, the position of the distal end of the boom 14a) by a predetermined distance (for example, 50 cm). In other words, the position-related information regarding the position directly below the distal end of the arm section is not limited to the cross line.

In the image captured by the camera 30, the position of the camera 30 is calculated on the basis of the orientation of the boom 14a, and the coordinate position of the image range displayed in the monitor 31 is specified together with the rotation angle of the camera 30. Separately, the coordinate position of the distal end of the boom 14a is calculated on the basis of the orientation of the boom 14a. Therefore, the position directly below the distal end of the boom 14a can be indicated within the range of the image in the monitor 31.

There is a problem, unique to a mobile crane, that the angle of the camera 30 is likely to vary because the camera 30 is attached to the distal end of the long boom 14a. In view of this, the image control unit 401 of the control system S according to the present embodiment can accurately estimate and display the true position directly below the distal end of the boom 14a by correcting the image data on the basis of the camera angle (information regarding the angle of the camera) measured by the camera angle meter 25, the boom length (information regarding the length of the arm section) measured by the boom length meter 233, the raising angle (information regarding the raising angle of the arm section) measured by the raising angle meter 231, and deflection angle information (information regarding the deflection angle) of the distal end due to the weight of the boom 14a stored in advance in the controller 40. When the mobile crane includes the jib 14b, the information regarding the length of the arm section, the information regarding the raising angle of the arm section, and the information regarding the deflection angle include information regarding the jib 14b.

As will be described later, when lifting the cargo off the ground, the operator confirms that the position of the boom 14a (that is, the position of the marker M) has moved to a position within a predetermined distance range from the position of the center of gravity of the cargo, and presses a confirmation button (not shown) (that can be added to a safety device), whereby an actual hoisting operation can be started.

As another method, the position of the hook 17 attached to the cargo may be recognized (assumed) as the position of the center of gravity of the cargo, and the hoisting operation may be automatically started when the center position of the marker M and the position of the hook 17 are within a predetermined distance range (for example, 50 cm or less) (in other words, when a predetermined condition is satisfied). In this case, it is also preferable to mount an electronic tag (RFID) or the like on the hook 17 in order to automatically recognize the position of the hook 17.

The boom 14a, the camera 30, the monitor 31, and the image control unit 401 described above constitute the control system S according to the present embodiment.

On the other hand, as described above, the controller 40 also has a function as the boom control unit 402 that controls the operations of the boom 14a and the winch 13. That is, when the liftoff switch 20 is turned on to lift the cargo by winding up the winch 13, the boom control unit 402 of the controller 40 predicts an amount of change in the raising angle of the boom 14a on the basis of a temporal change in the load measured by the load measuring unit 22, and raises the boom 14a so as to compensate for the predicted amount of change. In this manner, the controller 40 maintains a state in which the position of the center of gravity of the cargo (the position of the hook 17) and the center position of the marker M (the position directly below the distal end of the arm section 14 indicated by the position-related information) satisfy the predetermined condition.

In other words, when lifting the cargo, the controller 40 raises the arm section 14 so that the position of the center of gravity of the cargo (the position of the hook 17) and the center position of the marker M (the position directly below the distal end of the arm section 14 indicated by the position-related information) can be maintained in the state satisfying the predetermined condition. The state satisfying the predetermined condition includes a state in which a distance in a horizontal direction between the position of the center of gravity of the cargo (position of the hook 17) and the center position of the marker M (the position directly below the distal end of the arm section 14 indicated by the position-related information) is included within a predetermined distance range.

More specifically, the boom control unit 402 includes, as functional units, a selection function unit 40a for selecting a characteristic table or a transfer function, and a liftoff determination function unit 40b that determines whether or not the cargo has been actually lifted off the ground and stops the liftoff control.

The selection function unit 40a for selecting a characteristic table or a transfer function receives an input of an initial value of the pressure from the load measuring unit 22 (pressure gauge) and an initial value of the raising angle from the raising angle meter 231 serving as the orientation detecting unit 23, and determines the characteristic table or transfer function to be applied. Here, as the transfer function, a relationship using a linear coefficient a can be applied as follows.

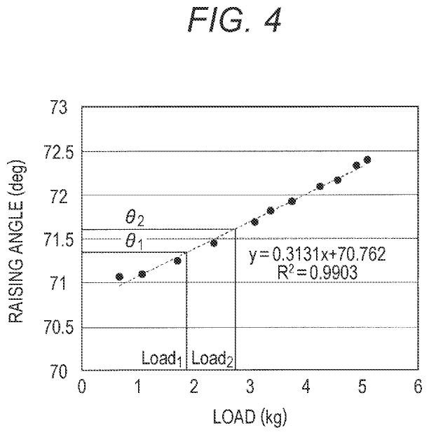

First, as shown in a load-raising angle graph of FIG. 4, it is found that the load and the raising angle (angle of the distal end to the ground) have a linear relationship when the position of the distal end of the boom is adjusted so as to be always positioned directly above the cargo in order to prevent the swing of the cargo. Assuming that a load Load₁ changes to Load₂ between a time t₁ and a time t₂ during the liftoff, Mathematical formula 1 is established.

[Mathematical formula 1]

θ=a·Load+b approximation formula

θ₁=a·Load₁+b t₁

θ₂=a·Load₂+b t₃

The difference equation is obtained from the difference between the two formulas.

θ₂−θ₁=a(Load₂−Load₁)

Δθ=a·ΔLoad [Mathematical formula 2]

In order to control the raising angle, it is necessary to give a raising angular velocity.

$${V}_{Dm} = \frac{Δθ}{( {t}_{2} - {t}_{1} )} = a \cdot \frac{Δ Load}{Δ t} = a \cdot {\dot{L}}_{Load} \qquad [ Mathematical formula 3 ]$$

Here, a is a constant (linear coefficient).

That is, in the raising angle control, a temporal change (differential) of the load is used as an input.

The liftoff determination function unit 40b monitors time-series data of the value of the load calculated from the pressure signal from the load measuring unit 22 (pressure gauge), and determines whether or not the cargo is lifted off the ground. A method for determining the liftoff will be described later with reference to FIGS. 9A to 9C.

(Overall Block Diagram)

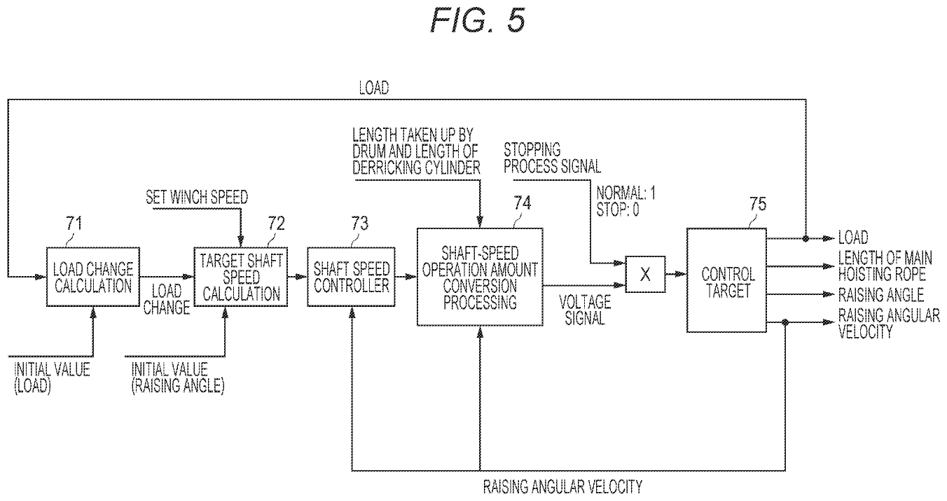

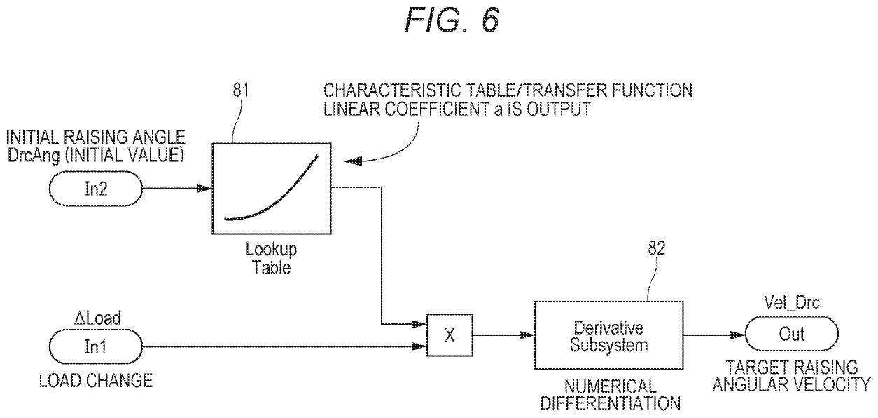

Next, an input/output relationship among all elements including the liftoff control of the present embodiment will be described in detail with reference to a block diagram of FIG. 5. First, a load change calculation unit 71 calculates a load change on the basis of time-series data of the load measured by the load measuring unit 22. The calculated load change is input to a target shaft speed calculation unit 72. The input/output relationship for the target shaft speed calculation unit 72 will be described later with reference to FIG. 6.

The target shaft speed calculation unit 72 calculates a target shaft speed on the basis of the initial value of the raising angle, the set winch speed, and the input load change. Here, the target shaft speed is a target raising angular velocity (and, although not required, a target winch speed). The calculated target shaft speed is input to the shaft speed controller 73. The first half control described above indicates processing related to the liftoff control according to the present embodiment.

Thereafter, an operation amount is input to a control target 75 via the shaft speed controller 73 and a shaft-speed operation amount conversion processing unit 74. The second half control described above indicates processing related to normal control, and feedback control is performed on the basis of the measured raising angular velocity.

(Block Diagram of Liftoff Control)

Next, an input/output relationship of elements in the target shaft speed calculation unit 72 during the liftoff control will be particularly described with reference to a block diagram of FIG. 6. First, an initial value of the raising angle is input to a selection function unit 81 (40a) for selecting characteristic table/transfer function. In the selection function unit 81, the most appropriate constant (linear coefficient) a is selected using a characteristic table (lookup table) or a transfer function.

Then, numerical differentiation (differentiation with respect to time) of the load change is performed in a numerical differentiation unit 82, and the target raising angular velocity is calculated by multiplying the result of the numerical differentiation by the constant a. That is, the target raising angular velocity is calculated by executing the calculation of (Mathematical formula 3) described above. As described above, the target raising angular velocity is obtained by feedforward control using the characteristic table (or the transfer function).

(Flowchart)

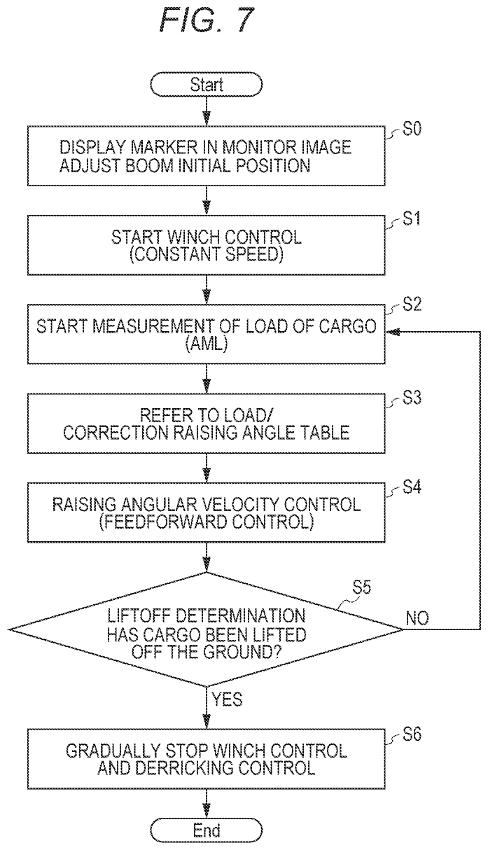

Next, the overall flow of the liftoff control of the present embodiment will be described with reference to the flowchart of FIG. 7.

First, the operator presses the liftoff switch 20 to start the liftoff control (START). Note that, in the following, a case where the arm section 14 includes the boom 14a and the jib 14b as in the mobile crane 1 illustrated in FIGS. 9A to 9C will be described. Therefore, the camera 30 is provided at the distal end of the jib 14b. The following description can also be applied, as appropriate, to a case where the mobile crane 1 includes only the boom 14a as the arm section 14.

Then, an image captured by the camera 30 is displayed in the monitor 31 in the operator cab 18, and as illustrated in FIG. 8, a cross line which is the marker M indicating the position directly below the distal end of the arm section 14 (jib 14b) is displayed so as to be superimposed on the captured image. While viewing the image in the monitor 31, the operator adjusts the position of the arm section 14 (jib 14b) so that the position of the distal end of the arm section 14 (jib 14b) approaches the position of the center of gravity of the cargo (which may be regarded as substantially the position of the hook 17) (step S0).

Then, the operator confirms that the position of the arm section 14 (jib 14b) (that is, the position of the marker M) has moved to a position within a predetermined distance range from the position of the center of gravity of the cargo, and presses the confirmation button (not shown), whereby an actual hoisting operation is started. Alternatively, when the distance between the position of the hook 17 (regarded as the position of the center of gravity of the cargo) and the center position of the marker M is equal to or less than a predetermined distance, the controller 40 automatically starts the hoisting operation (step S0).

At this time, a target speed of the winch 13 is set in advance using the winch speed setting unit 21 before or after the start of the liftoff control. Then, the controller 40 starts winch control at the target speed (step S1).

Next, at the same time as the winch 13 is wound up, the measurement of the load of the cargo is started by the load measuring unit 22, and a load value is input to the controller 40 (step S2). Then, the selection function unit 40a determines a characteristic table or a transfer function to be applied in response to the input of the initial value of the load and the initial value of the raising angle from the raising angle meter 231 serving as the orientation detecting unit 23 (step S3).

Next, the controller 40 calculates a raising angular velocity on the basis of the applied characteristic table or transfer function and the load change (step S4). That is, the raising angular velocity control is performed by feedforward control.

Then, whether or not the cargo is lifted off the ground is determined on the basis of the time-series data of the measured load (step S5). The determination method will be described later. When the cargo is not yet lifted off the ground as a result of the determination (NO in step S5), the process returns to step S2, and the feedforward control based on the load is repeated (steps S2 to S5).

When the cargo is lifted off the ground as a result of the determination (YES in step S5), the liftoff control is gradually stopped (step S6). That is, the rotational driving of the winch 13 by the winch motor is stopped while reducing the speed, and the derricking driving by the derricking cylinder 62 is stopped while reducing the speed.

(Liftoff Determination)

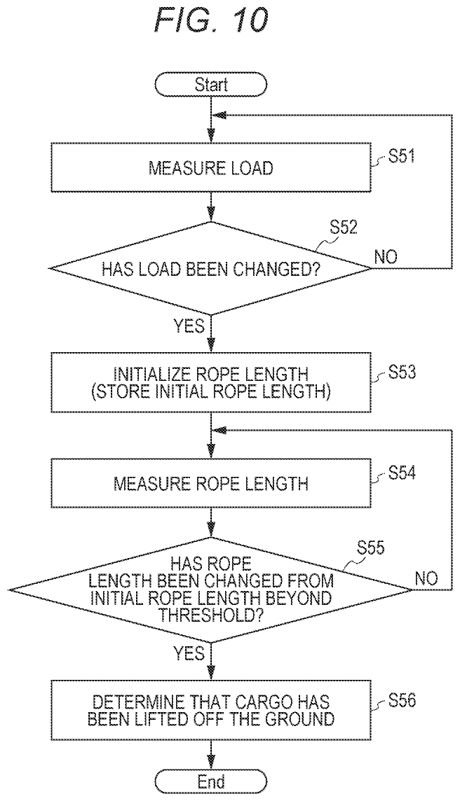

Next, a liftoff determination device C and a liftoff determination method according to the present embodiment will be described in detail with reference to FIGS. 9A to 9C and 10. The liftoff determination device C includes the arm section 14 (boom 14a and jib 14b), the winch 13, the load measuring unit 22, the rope length/hoisting speed measuring unit 24, and the controller 40 serving as a control unit that controls the arm section 14 (boom 14a and jib 14b) and the winch 13.

During the liftoff control, the controller 40 in the present embodiment determines liftoff on the basis of a temporal change in the measured load and a temporal change in the measured rope length when lifting the cargo by winding up the winch 13.

Specifically, when lifting the cargo by winding up the winch 13, the controller 40 serving as the control unit sets the rope length at a timing at which the measured load starts to change as an initial rope length, and determines that the cargo is lifted off the ground when the rope length is shorter than a set threshold from the initial rope length.

Alternatively, when lifting the cargo by winding up the winch 13, the controller 40 serving as the control unit sets the temporal change in the rope length at a timing at which the measured load starts to change as an initial hoisting speed, and determines that the cargo is lifted off the ground when the hoisting speed indicating the temporal change in the rope length is higher than a set threshold from the initial hoisting speed.

That is, as illustrated in FIG. 9A, at the start of liftoff, when the winch 13 is wound up, almost no load is exerted, because the wire rope 16 is slackened. Therefore, when the winch is continuously wound up, the weights of the wire rope 16 and the hook 17 are exerted. When the winch 13 is further wound up, the load increases (changes) while bending the arm section 14 (boom 14a) as illustrated in FIG. 9B. When the load changes beyond a predetermined threshold, the rope length is initialized. Thereafter, when the winch 13 is further wound up, the rope length is suddenly shortened after the arm section 14 (boom 14a) deflects maximally as illustrated in FIG. 9C. The time point at which the rope length has suddenly changed in this way can be obtained and determined as a liftoff time.

Alternatively, when the load changes beyond a predetermined threshold, the temporal change in the rope length, that is, the hoisting speed is initialized. Thereafter, when the winch 13 is further wound up, the hoisting speed is suddenly increased after the arm section 14 (boom 14a) deflects maximally as illustrated in FIG. 9C. The time point at which the hoisting speed has suddenly changed in this way can be obtained and determined as a liftoff time.

That is, the liftoff determination method according to the present embodiment includes a step of winding up the winch 13, a step of measuring a load, a step of measuring a rope length of the wire rope 16, a step of storing the rope length at a timing at which the load starts to change as an initial rope length, and a step of determining that the cargo is lifted off the ground when the rope length is shorter than a set threshold from the initial rope length.

Alternatively, the liftoff determination method according to the present embodiment includes a step of winding up the winch 13, a step of measuring a load, a step of measuring a hoisting speed of the wire rope 16, a step of storing the hoisting speed at a timing at which the load starts to change as an initial hoisting speed, and a step of determining that the cargo is lifted off the ground when the hoisting speed is higher than a set threshold from the initial hoisting speed.

The liftoff determination method will be described below with reference to a flowchart of FIG. 10. Here, only the liftoff determination method will be described with reference to the flowchart of FIG. 10. The overview of the liftoff control method is as described with reference to FIG. 7. That is, the process of the liftoff determination in step S5 in the flowchart of FIG. 7 will be described here.

As illustrated in the flowchart of FIG. 10, the liftoff determination method is divided into a first half part for obtaining a change in the load (steps S51 and S52) and a second half part for obtaining a change in the rope length (or hoisting speed) (steps S53 to S55). The following description is given based on the premise that the load is measured in step 351 for convenience of description.

In the first half part, a load is first measured by the load measuring unit 22, and time-series data of the load is monitored by the controller 40 (step S51). When the load has changed beyond the threshold (YES in step 352), the controller 40 initializes the rope length (step 353). That is, a rope length RO at the time at which the rope length exceeds the threshold is stored. On the other hand, when the load has not changed beyond the threshold (NO in step S52), the controller 40 continues the measurement of the load (steps 351 and 352).

In the second half part, the rope length is first measured by the rope length/hoisting speed measuring unit 24, and time-series data of the rope length is monitored by the controller 40 (step S54). When the rope length is shorter than the threshold from the initial rope length RO (YES in step S55), the controller 40 determines that the cargo is lifted off the ground (step S56). On the other hand, when the rope length is not shorter than the threshold from the initial rope length RO (NO in step S55), the controller 40 continues the measurement of the rope length (steps S54 and S55).

Alternatively, although not illustrated, when the temporal change in the rope length, that is, the hoisting speed, is higher than the threshold from an initial hoisting speed VO (corresponding to YES in step S55), the controller 40 determines that the cargo is lifted off the ground (corresponding to step S56). On the other hand, when the hoisting speed is not higher than the threshold from the initial hoisting speed VO (corresponding to NO in step S55), the controller 40 continues the measurement of the rope length (hoisting speed) (corresponding to steps S54 and S55).

In this way, whether or not the cargo is lifted off the ground is determined by the process and determination regarding a change in the load (steps S51 and S52) and the process and determination regarding a change in the rope length (or hoisting speed) (steps S53 to S55).

(Effects)

Next, effects provided by the control system S, the liftoff determination device C, the liftoff control device D, and the mobile crane 1 according to the present embodiment will be listed and described.

(1) As described above, the control system S according to the present embodiment includes: the arm section 14 (boom 14a and jib 14b) that is freely raised and lowered; the camera 30 that is provided at the distal end of the arm section 14 (jib 14b) and captures an image of an area below; the monitor 31 that displays the captured image; and the image control unit 401 that controls the image displayed in the monitor 31. The image control unit 401 causes the monitor 31 to display the marker M indicating the position directly below the distal end of the arm section 14 (jib 14b) so as to be superimposed on the image. With this configuration, the operator can easily bring the initial position of the distal end of the boom close to a position directly above the position of the center of gravity of the cargo by using the camera 30.

That is, the operator adjusts the position of the arm section 14 (boom 14a and jib 14b) while viewing the position of the marker M displayed in the monitor 31 in real time, thereby being capable of easily moving the initial position of the distal end of the arm section 14 (jib 14b) to the position almost directly above the cargo. This configuration is significantly effective particularly in a case where, for example, the operator cannot see the area around the cargo from the operator cab 18 due to an obstacle or the like being present. The control system S is applied to the feedforward control, whereby it is possible to prevent swing of the cargo caused by the displacement of the initial position.

(2) In addition, it is preferable that the control system S further includes the boom control unit 402 that controls the operation of the arm section 14 (boom 14a), and the boom control unit 402 starts a liftoff operation for the arm section 14 (boom 14a and jib 14b) when the marker M moves to a position within a predetermined distance range from the position of the center of gravity of the cargo at the time of lifting the cargo off the ground. With this configuration, the operator performs the liftoff operation after recognizing the initial position of the distal end of the arm section 14 (jib 14b), so that it is easy to prevent the displacement of the initial position of the distal end of the arm section 14 (jib 14b).

(3) It is also preferable that the control system S further includes the hook 17 that is suspended from the distal end of the arm section 14 (jib 14b) via the wire rope 16, and the boom control unit 402 recognizes the position of the hook 17 as the position of the center of gravity of the cargo. With this configuration, the position of the hook 17 can be recognized by image recognition, or with an electronic tag, or the like, so that the initial position of the distal end of the arm section 14 (jib 14b) can be fully automatically adjusted.

(4) It is also preferable that the control system S further includes the load measuring unit 22 that measures a load acting on the arm section 14 (boom 14a), and the boom control unit 402 obtains an amount of change of the raising angle of the arm section 14 (boom 14a) on the basis of a temporal change in the measured load, and raises the arm section 14 (boom 14a) to compensate for the amount of change when lifting the cargo off the ground. Due to the configuration in which the control system S is applied to the feedforward control, it is possible to prevent the swing of the cargo caused by the displacement of the initial position.

(5) The control system S further includes the camera angle meter 25 that measures an angle of the camera 30 with respect to the arm section 14 (jib 14b), the boom length meter 233 that measures the length of the arm section 14 (boom 14a and/or jib 14b), and the raising angle meter 231 that measures a raising angle of the arm section 14 (boom 14a and/or jib 14b), and the image control unit 401 estimates a position directly below the distal end of the arm section 14 (boom 14a and/or jib 14b) on the basis of the measured camera angle, the measured boom length, the measured raising angle, and deflection angle information due to the weight of the arm section 14 (boom 14a and/or jib 14b) stored in advance. With this configuration, the position directly below the distal end of the arm section (boom 14a and/or jib 14b) can be accurately estimated and displayed in the monitor 31. There is a problem, unique to a mobile crane, that the angle of the camera 30 is likely to vary because the camera 30 is attached to the distal end of the long arm section 14 (boom 14a and/or jib 14b). In view of this, the above configuration is applied, whereby the position directly below the distal end of the arm section 14 (boom 14a and/or jib 14b) can be estimated with high accuracy while following a variation in angle of the camera 30 in real time.

(6) In addition, the liftoff determination device C includes: the arm section 14 that is freely raised and lowered; the winch 13 that hoists/lowers the cargo via the wire rope 16; the load measuring unit 22 that measures a load acting on the arm section 14; the rope length/hoisting speed measuring unit 24 that measure a rope length of the wire rope 16; and the controller 40 that controls the arm section 14 and the winch 13, wherein the controller 40 determines liftoff on the basis of a temporal change in the measured load and a temporal change in the measured rope length when lifting the cargo off the ground by winding up the winch 13. With this configuration, it is possible to quickly determine the liftoff by a simple method while suppressing swing of the cargo.

That is, there is a slight time difference from when a change in the load is observed to when the cargo is actually lifted off the ground due to the characteristics of the load measuring unit 22. While the time difference is generated, monitoring of the liftoff is started, and the liftoff is determined by the rope length/hoisting speed measuring unit 24 having good responsiveness. Accordingly, the liftoff determination device C can be configured to have good responsiveness with a simple configuration. Furthermore, the liftoff determination device C can also be used to set coordinates for route control on the basis of the relationship between the rope length and the lifting height of the cargo.

(7) Specifically, when lifting the cargo by winding up the winch 13, the controller 40 sets the rope length at a timing at which the measured load starts to change as an initial rope length RO, and determines that the cargo is lifted off the ground when the rope length is shorter than a set threshold from the initial rope length RO.

(8) Alternatively, when lifting the cargo by winding up the winch 13, the controller 40 sets the temporal change in the rope length at a timing at which the measured load starts to change as an initial hoisting speed VO, and determines that the cargo is lifted off the ground when the hoisting speed indicating the temporal change in the rope length is higher than a set threshold from the initial hoisting speed VO.

(9) In addition, the liftoff control device D according to the present embodiment includes the arm section 14 (boom 14a), the winch 13, the load measuring unit 22, and the controller 40 serving as the control unit that controls the arm section 14 and the winch 13, the controller 40 obtaining an amount of change of the raising angle of the arm section 14 (boom 14a) on the basis of a temporal change in the measured load and raising and lowering the arm section (boom 14a) to compensate for the amount of change when lifting the cargo off the ground by winding up the winch 13. With this configuration, the liftoff control device D can quickly lift the cargo off the ground while suppressing swing of the cargo.

That is, focusing on the linear relationship between the load and the raising angle correction amount, the liftoff control device D according to the present embodiment performs feedforward control on the basis of only a temporal change in the load value, thereby being capable of quickly lifting the cargo off the ground without performing complicated feedback control that is conventionally performed.

(10) It is also preferable that the liftoff control device D further includes the orientation detecting unit 23 that measures the orientation of the arm section 14 (boom 14a), and the controller 40 selects a corresponding characteristic table or transfer function on the basis of an initial value of the measured orientation of the arm section 14 (boom 14a) and an initial value of the measured load, and obtains an amount of change of the raising angle of the arm section 14 (boom 14a) from a temporal change in the measured load using the characteristic table or transfer function.

With this configuration, at the start of the liftoff control, the winch 13 is wound up at a constant speed, and a raising angle control amount is calculated from the characteristic table (or the transfer function) in accordance with the load change to perform the feedforward control, so that the cargo can be quickly lifted off the ground without swinging. In addition, the number of parameters to be adjusted is reduced, whereby adjustment at the time of shipment can be quickly and easily performed.

(11) In addition, it is preferable that the controller 40 winds up the winch 13 at a constant speed when lifting the cargo off the ground by winding up the winch 13. With this configuration, the response (measured load value) is stabilized by suppressing an influence of disturbances such as inertial force, and thus, whether or not the cargo is lifted off the ground can be easily determined.

(12) In addition, the mobile crane 1 according to the present embodiment includes any one of the control system S, the liftoff determination device C, and the liftoff control device D described above, so that the mobile crane 1 is capable of quickly lifting the cargo off the ground while suppressing swing of the cargo caused by the displacement of an initial position.

(13) In addition, the liftoff determination method according to the present embodiment includes a step of winding up the winch 13, a step of measuring a load, a step of measuring a rope length of the wire rope 16, a step of storing the rope length at a timing at which the load starts to change as an initial rope length RO, and a step of determining that the cargo is lifted off the ground when the rope length is shorter than a set threshold from the initial rope length RO. With this configuration, it is possible to quickly determine the liftoff by a simple method while suppressing the swing of the cargo.

(14) In addition, another liftoff determination method according to the present embodiment includes a step of winding up the winch 13, a step of measuring a load, a step of measuring a hoisting speed of the wire rope 16, a step of storing the hoisting speed at a timing at which the load starts to change as an initial hoisting speed VO, and a step of determining that the cargo is lifted off the ground when the hoisting speed is higher than a set threshold from the initial hoisting speed VO. With this configuration, it is possible to quickly determine the liftoff by a simple method while suppressing the swing of the cargo.

While the embodiments of the present invention have been described in detail with reference to the drawings, the specific configuration is not limited to the embodiments, and a design change that does not depart from the gist of the present invention is included in the present invention.

For example, although not specifically described in the embodiment, the control system S and the liftoff control device D according to the present invention can also be applied to a case where a cargo is lifted off the ground using a main winch as the winch 13 and a case where the cargo is lifted off the ground using a sub winch as the winch 13.

In addition, although the embodiment describes the case where the control system S is applied to feedforward control, the configuration is not limited thereto, and it is obvious that the control system S according to the present embodiment can also be applied to a conventional liftoff method.

The entire disclosure of the specification, drawings, and abstract included in Japanese Patent Application No. 2019-174638 filed on Sep. 25, 2019 is incorporated herein by reference.

### INDUSTRIAL APPLICABILITY

The present invention can be applied to various work machines including an arm section that is freely raised and lowered.

### REFERENCE SIGNS LIST

C Liftoff determination device
D Liftoff control device
S Control system
a Linear coefficient
1 Rough terrain crane
10 Chassis
11 Outrigger
12 Slewing base
13 Winch
14 Arm section
14a Boom
14b Jib
15 Derricking cylinder
16 Wire rope
17 Hook
18 Operator cab
19 Counterweight
20 Liftoff switch
21 Winch speed setting unit
22 Load measuring unit
23 Orientation detecting unit
231 Raising angle meter
232 Raising angular velocity meter
233 Boom length meter
24 Rope length/hoisting speed measuring unit
25 Camera angle meter
30 Camera
31 Monitor
40 Controller
40a Selection function unit
40b Liftoff determination function unit
401 Image control unit
402 Boom control unit
40a Selection function unit
40b Liftoff determination function unit
51 Slewing lever
52 Derricking lever
53 Telescoping lever
54 Winch lever
61 Slewing motor
62 Derricking cylinder
63 Telescoping cylinder
64 Winch motor
71 Load change calculation unit
72 Target shaft speed calculation unit
73 Shaft speed controller
74 Shaft-speed operation amount conversion processing unit
75 Control target
81 Selection function unit
82 Numerical differentiation unit
141 Base boom
142 Intermediate boom
143 Tip boom
144 Boom head

1. A control system incorporated in a work machine having an arm section including a boom that is freely raised and lowered, the control system comprising:
an image-capturing unit that is provided at a distal end of the arm section and captures an image of an area below;
a display unit that displays an image captured by the image-capturing unit; and
a control unit that causes the display unit to display position-related information regarding a position directly below the distal end of the arm section so as to be superimposed on the image.

2. The control system according to claim 1, wherein the control unit starts a liftoff operation for lifting a cargo when a position of a center of gravity of the cargo and the position directly below the distal end indicated by the position-related information satisfy a predetermined condition.

3. The control system according to claim 2, wherein, when lifting the cargo, the control unit raises the arm section so that the position of the center of gravity of the cargo and the position directly below the distal end indicated by the position-related information are capable of being maintained in a state satisfying the predetermined condition.

4. The control system according to claim 3, wherein, when lifting the cargo, the control unit obtains an amount of change in a raising angle of the arm section on the basis of a temporal change in a load acting on the arm section, and raises the boom to compensate for the amount of change in order that the position of the center of gravity of the cargo and the position directly below the distal end indicated by the position-related information is maintained in a state satisfying the predetermined condition.

5. The control system according to claim 2, wherein the state satisfying the predetermined condition includes a state in which a distance in a horizontal direction between the position of the center of gravity of the cargo and the position directly below the distal end indicated by the position-related information is included within a predetermined distance range.

6. The control system according to claim 2, wherein the control unit calculates the position of the center of gravity of the cargo on the basis of a position of a hook suspended from the distal end of the arm section via a wire rope.

7. The control system according to claim 1, wherein the control unit estimates the position directly below the distal end of the arm section on the basis of information regarding an angle of the image-capturing unit, information regarding a length of the arm section, information regarding a raising angle of the arm section, and previously stored information regarding a deflection angle of the arm section due to a weight of the arm section.

8. A work machine comprising:
an arm section including a boom that is freely raised and lowered; and
the control system according to claim 1.
